(19) United States
(12) Patent Application Publication
(10) Pub. No.: US 2026/0080382 A1
(43) Pub. Date: Mar. 19, 2026

(54) FINANCIAL PROFILE TO DEVICE SYNCHRONIZATION

(71) Applicant: Wells Fargo Bank, N.A., San Francisco, CA (US)

(72) Inventors: Ramya Balasubramanian, Hyderabad (IN); Rameshchandra Bhaskar Ketharaju, Hyderabad (IN); Balaji Lakshmipathi, Chennai (IN); Venkata Sai Jyothsna Munipalle, Ongole (IN); Priyanka Subramanian, Chennai (IN)

(21) Appl. No.: 18/889,746

(22) Filed: Sep. 19, 2024

(51) Int. Cl. G06Q 20/12

(52) U.S. Cl. CPC G06Q 20/127

(57) ABSTRACT

Synchronizing a service providing device to a financial profile. The financial profile can include limitations on services, such as subscriptions for a variety of different services. The financial profile can be used to configure dynamic financial protocols for making payments to the different service providers that provide the different services according to the limitations.

When a computing device associated with the financial profile is detected to be at a location near a service providing device, the service providing device is automatically synced to the financial profile, causing the service providing device to provide the service according to the corresponding limitations of the financial profile, and causing the service provider associated with the service providing device to be paid for the service using the corresponding dynamic financial protocol configured using the financial profile.

### RELATED APPLICATION

This application relates to U.S. patent application Ser. No. 18/889,551 filed on Sep. 19, 2024 (the '551 application), the contents of which are incorporated by reference herein in their entirety.

### BACKGROUND

Devices can provide different services. For example, a modem or router can provide access to the Internet, an air conditioner can provide air conditioning, and a media playback device can stream media content, such as songs and movies. Customers can subscribe to different services with subscriptions that define the limitations of the services that will be provided to the customers and how much the customers must pay the service providers for providing the services.

### SUMMARY

Examples provided herein are directed to syncing a service providing device to a financial profile. The syncing can cause the service providing device to provide a service according to an attribute of the financial profile and for the service provider to be paid for the service based on a dynamic financial protocol of the financial profile.

According to one aspect, the present disclosure relates to a computer system for synchronizing a financial profile to a device, the computer system including: one or more processors; and non-transitory computer-readable storage media encoding instructions which, when executed by the one or more processors, causes the computer system to: receive a message from a computing device indicating that the computing device and a service providing device are positioned to communicate with each other through a network, the service providing device being configured to provide a service; send a prompt to the computing device, the prompt requesting whether the service providing device should be synchronized to the financial profile, the financial profile being used to configure a dynamic financial protocol for paying a service provider associated with the service providing device; receive a response to the prompt from the computing device, the response requesting to synchronize the service providing device to the financial profile; and based on the response, synchronize, via the network, the service providing device to the financial profile.

According to another aspect, the present disclosure relates to a method of using a service providing device, the method including: detecting that the service providing device and a computing device are positioned to communicate with each other through a network; identifying, based on the detecting, a portion of a financial profile that corresponds to a service provider associated with the service providing device, the financial profile including different portions, corresponding, respectively, to different service providers that provide, respectively, different services, the portion of the financial profile being one of the different portions; causing the service providing device to provide the service according to an attribute included in the portion of the financial profile; and paying the service provider for the service based on a dynamic financial protocol, the dynamic financial protocol being configured based on the portion of the financial profile.

According to another aspect, the present disclosure relates to a system for synchronizing a financial profile to a device, the system including: a server; a database accessible by the server, the database storing the financial profile, the financial profile including different portions corresponding, respectively, to different service providers that provide, respectively, different services, the different portions including different attributes that define limits on consumption, respectively, of the different services, the different portions being used to configure different dynamic financial protocols for making payments from one or more payor transaction accounts to payee transaction accounts, the payee transaction accounts corresponding, respectively, to the different service providers; a service providing device configured to provide one of the different services; a computing device; one or more processors; and non-transitory computer-readable storage media encoding instructions which, when executed by the one or more processors, causes the system to: determine that the service providing device and the computing device are positioned to communicate with each other through a network; identify one of the different portions of the financial profile that corresponds to the service providing device; provide, by the service providing device, the one of the different services based on one or more of the different attributes, the one or more of the different attributes being included in the one of the different portions; and make a payment for the one of the different services from one of the one or more payor transaction accounts to one of the payee transaction accounts identified in one of the different dynamic financial protocols, the one of the different dynamic financial protocols being included in the one of the different portions.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for syncing a service providing device to a financial profile.

FIG. 2 shows further details of information used by the system of FIG. 1 to generate financial profiles.

FIG. 3 shows an example message generated by the server of FIG. 1 according to an example dynamic financial protocol generated and configured using the financial profile of the system of FIG. 1.

FIG. 4 shows an example method that can be performed using the system of FIG. 1.

FIG. 5 shows another example method that can be performed using the system of FIG. 1.

FIG. 6 shows example physical components of one or more devices of the system of FIG. 1.

### DETAILED DESCRIPTION

This disclosure relates to syncing a service providing device to a financial profile.

In general, the present disclosure relates to seamlessly transferring financial profiles to devices and machines when financial institution customers associated with those financial profiles visit new locations.

Typically, service subscriptions for various services such as access to the Internet, other utilities (e.g., water, gas, oil, electricity), media streaming, and the like are managed separately, with separate accounts, separate login credentials, separate payment terms and payment methods, and the like. As a result, setting up a third party service providing device, such as a WiFi router or a smart television in a hotel room or at a friend's house, can be a hassle, requiring login information and credentials to be input to the service providing device (e.g., an internet of things (IOT) device) sought to be used.

In addition, a typical service providing device can be set up to provide service for just one service account at a time, and there is no convenient or automated way to split the cost of the service provided by the service providing device between multiple service accounts.

The present disclosure provides one or more solutions to these problems.

According to the present disclosure, financial profiles can be synced to service-providing devices in real-time while maintaining security and privacy. For instance, a customer arrives at a hotel equipped with various Internet of Things (IoT) devices. According to the present disclosure, upon entering the hotel room, the customer's smartphone or other computing device (e.g., a smartwatch) automatically detects the new environment and initiates a financial profile syncing request to the hotel room's IoT devices. As a result, one or more of the customer's preferred financial settings, such as utility subscriptions, entertainment subscriptions, payment preferences (payment gateways, preferred payment methods, etc.), security layers on open network devices, rentals, sustainability profiles (accumulation of carbon credits and spending in carbon credits), rewards and loyalty points, along with the generic customer preferences such as lighting, temperature, and entertainment preferences, seamlessly sync with the smart lights, thermostat, television, and other IoT devices in the hotel room.

As a result, the customer's financial experience becomes a consistent and personalized experience throughout the hotel stay, as their financial profile dynamically adapts to each device's payment and service functionality.

Additionally, when the customer checks out of the hotel room and/or leaves the hotel room, the bill is automatically settled and payment is settled for the stay according to attributes of the financial profile, and the financial profile is automatically disengaged from the hotel's devices, ensuring privacy and security.

Customers can associate their financial profiles with specific services or subscriptions, enabling personalized experiences based on their preferences. For instance, a media content subscription can be accessible on a friend's devices when visiting the friend's home. Devices dynamically pair with the customer's financial profile and service provider for billing and payment processing. For example, when connecting to a friend's Wi-Fi network, the customer's financial profile is synced to an Internet service provider for accurate billing. For instance, if the customer has 1 gigabit per second (GBPS) data streaming speed as part of their service plan while the friend has 2 GBPS data streaming service speed as part of their plan, once the syncing is done to the capable WiFi router, the WiFi router can be configured to provide the customer's device with 1 GPBS and the friend's device at 2 GBPS, and split the cost of the service based on the customer's internet service plan and the friend's internet service plan.

These and other solutions borne out in the present disclosure reflect improvements in technology. For example, service providing devices can be augmented to include functionality that enables them to be synced to a financial profile. As another example, control and operation of service providing devices is improved by syncing the devices to a financial profile.

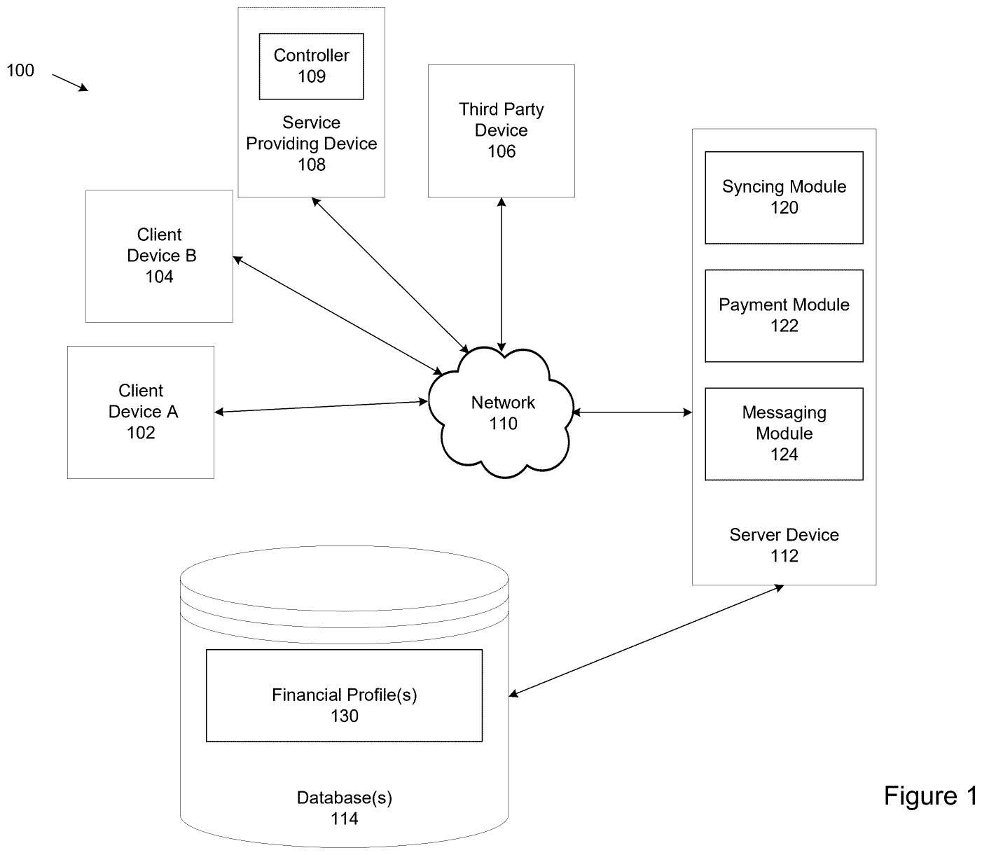

FIG. 1 schematically shows aspects of one example system 100 programmed to synchronize a service providing device to a financial profile. In this example, the system 100 can be a computing environment that includes a plurality of client and server devices. In this instance, the system 100 includes a client device A 102, a client device B 104, a service providing device 108, a third party device 106, a server device 112, and one or more databases 114. Each of the client devices 102, 104, the service providing device 108, and the third party device 106 can communicate with the server device 112 through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank.

The client devices 102 and 104 can be owned and/or operated by different customers of the financial institution. For example, the client device A 102 can be a smartwatch owned by a first customer of the financial institution and the client device B 104 can be a smartphone owned by a second customer of the financial institution. Many other configurations are possible.

The example client devices 102 and 104 are programmed to communicate with the server device 112 to conduct financial transactions. For instance, in one embodiment, the client device A 102 is a smartwatch, and the customer of the smartwatch initiates a financial transaction to make a payment to a service provider that is received by the third party device 106, for a service that is performed by the service providing device 108.

The service providing device 108 can be any device that can be networked with the client devices 102 and 104, the third party device 106, and the server device 112 and also provide a service. For example, the service providing device 108 can be one of a media playback device (e.g., a television, a tablet, a smartphone, and the like), an Internet providing device (e.g., a modem, a router), an air conditioner, a heater, an electric lighting device, a water providing device (e.g., a faucet), and the like. The service providing device 108 can include a controller 109 configured to control, via electronic signals, operation of the service providing device.

The example third party device 106 is programmed to complete financial transactions. In one example, the third party device 106 can be a computing device owned by a third party financial institution that manages a transaction account of a service provider the provides a service vie the service providing device. For example, a service provider can be a utility company that provides a utility (e.g., electricity, water), an Internet service provider (ISP), a media content provider (e.g., a music or video streaming company, a cable television company) and the like.

The server device 112 can communicate with the third party device 106 to conduct financial transactions. For instance, in the example above, the server device 112 can communicate with the third party device 106 to complete the payment from the customer of the client device 102 to the service provider.

The example server device 112 is programmed to facilitate financial transactions. In this example, the financial transactions can include the payment from the client device 102 to the third party device 106. In the examples detailed below, the server device 112 is programmed to facilitate these financial transactions using a dynamic financial protocol as described herein and in the '551 application. The dynamic financial protocol is generated and configured using a financial profile 130 stored on the database 114.

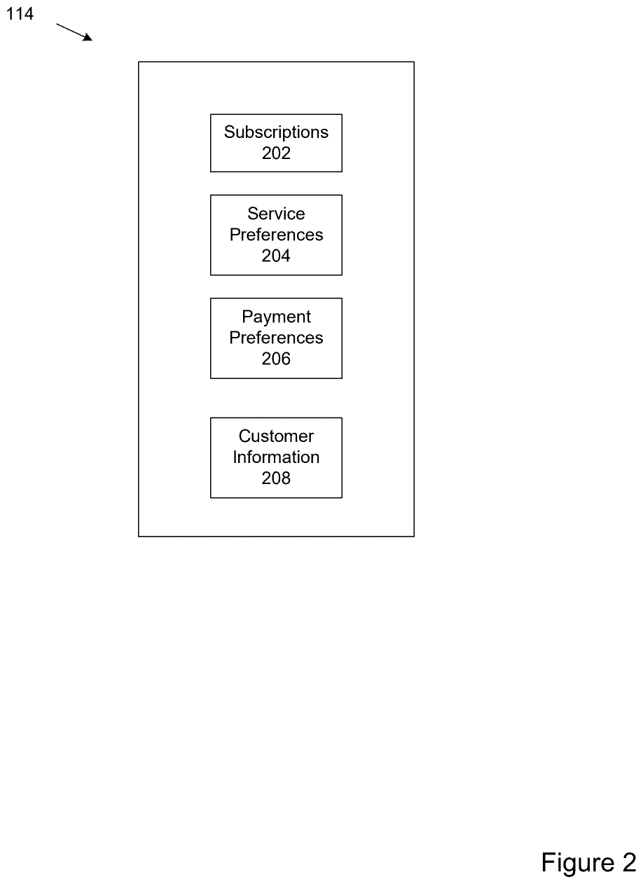

The example database 114 of the system 100 is programmed to store details associated with the financial transactions facilitated by the server device 112. The server device 112 accesses the one or more financial profiles 130 from the database(s) 114 to generate and configure dynamic financial protocols for preforming transactions as described herein. In some examples, the database 114 is a relational database, an objected-oriented database, a hierarchical database, and/or a cloud database that stores various components of one or more financial profiles 130 (as described in connection with FIG. 2) that facilitate the financial transactions described herein. Many other configurations are possible.

The network 110 provides a wired and/or wireless connection between the client devices 102, 104 and the server device 112. In some examples, the network 110 can be a local area network, a wide area network, the Internet, a near field communication (NFC) network, or a mixture thereof. Many different communication protocols can be used. Although only five devices are shown, the system 100 can accommodate hundreds, thousands, or more of computing devices.

The server device 112 includes software modules for performing functionalities of the system 100 described herein.

For example, the server device 112 can include a messaging module 124. The messaging module is configured to generate messages that the server device 112 sends to client devices when an event has occurred that indicates that a syncing of the service providing device 108 to a financial profile 130 may be appropriate.

The server device 112 can include a syncing module 120. The syncing module is configured to synchronize the service providing device 108 to a financial profile 130 in response to receiving a synchronization request from the client device 102 or the client device 104.

The server device 112 can include a payment module 122. The payment module 122 is configured to generate and configure a dynamic financial protocol based on the financial profile that has been synced to the service providing device 108, and to make a payment for a service provided by the service providing device 108 to the third party device 106 using the generated and configured dynamic financial protocol.

Referring now to FIG. 2, further details of information used by the system 100 of FIG. 1 to generate financial profiles 130 are shown. Each customer of the financial institution can have their own unique financial profile 130. Each financial profile 130 includes information that is used by the payment module 122 to generate and configure dynamic financial protocols which are then executed to make payments for one or more services provided by one or more service providing devices, such as the service providing device 108. Each financial profile 130 also includes information that is used by the syncing module 120 to control the service providing device 108 according to one or more attributes of the financial profile 130.

Generally, each customer has a corresponding financial profile 130. The information in each customer's financial profile 130 can be provided by the customer (e.g., uploaded or otherwise provide via a software application of the financial institution) and/or captured in other ways. The financial profile 130 allows seamless, automated control of service providing devices, such as the service providing device 108, as well as making appropriate payments for consumption of the services provided.

For example, a financial profile 130 can include one or more subscriptions 202. A subscription can include attributes, such as terms of a service agreement between the customer and the service provider. For example, a subscription 202 can be a service agreement between the customer and an ISP. Attributes of that subscription can include the data streaming rate the ISP provides to the customer, a data usage maximum, a price that the customer agrees to pay the ISP for Internet service, payee account information (e.g., a payee transaction account number and a bank routing number) for the ISP, an identification (e.g., an IP address) of the third party device 106, and the like.

As another example, a subscription 202 can be a service agreement between the customer and an electricity supplier. Attributes of that subscription can include payee account information (e.g., a payee transaction account number and a bank routing number) for the electricity supplier, an identification (e.g., an IP address) of the third party device 106, and a price per unit of energy (e.g., per kilowatt hour) that the customer has agreed to pay the electricity supply for electricity.

As another example, a subscription 202 can be a service agreement between the customer and a media content provider, such as a music content streaming service. Attributes of that subscription can include payee account information (e.g., a payee transaction account number and a bank routing number) for the music content streaming service provider, which media content (e.g., specific media content times or categories of media content items, such as specific artists or genres) the customer has access to and when the customer has access to them, and a price the customer agrees to pay to consume certain content, e.g., to download a particular song.

A financial profile 130 can also include one or more service preferences 204. Service preferences 204 can be set by the customer. When the financial profile 130 and the service providing device 108 are synchronized, any applicable service preference 204 is an attribute of the financial profile 130 that can be used to configure how the service providing device 108 provides the service and, concomitantly, what the cost for providing that service is and making the corresponding payment to the service provider.

For example, a service preference 204 can be a preferred temperature, e.g., in a hotel room. When the financial profile 130 is synced to an air conditioner or a heater in a hotel room, the attribute of the preferred temperature is used to automatically adjust a thermostat of the air conditioner or heater to the preferred temperature.

As another example, a server preference 204 can preferred brightness settings for room lighting.

Other example service preferences 204 can include a speaker volume for listening to media content, a media content playlist or a set of preferred media content items or artists, and the like.

A financial profile 130 can also include one or more payment preferences 206.

Payment preferences can include attributes that define, for each subscription 202, how the customer desires to pay the service provider of that subscription 202. For instance, the payment preferences 206 can include attributes that define, for each subscription 202, a specific payment gateway, one or more security layers, a specific payment platform, a specific payor transaction account number or credit card number from which to make the payment, and the like.

A financial profile 130 can also include customer information 208. The customer information 208 can include attributes that define identification information that can be used by the server device 112 to pair, for example, the client device 102, 104 with a particular financial profile 130. For instance, if a customer receives a prompt via their financial institution's software application installed on their client device 102 (e.g., smartphone) to synchronize that customer's financial profile with a service providing device 108, the customer's credentials used to log into the software application are cross-checked by the server device 112 against the customer information 208 to verify that the particular financial profile 130 belongs to the customer seeking to sync their financial profile with the service providing device 108.

The customer information 208 can include other forms of information. For instance, the customer information 208 can include attributes that define a sustainability profile for the customer in question. For instance, such a sustainability profile can indicate accumulations of carbon credits and spending in carbon credits that can limit how the customer may be able to receive the service provided by the service providing device 108. For instance, if the customer's financial profile 130 indicates that the customer has spent all of their allotted entertainment carbon credits for the current month, the financial profile 130 may prohibit the service providing device 108 (via the controller 109) from providing media content to the customer.

The customer information 208 can also include attributes that define rewards and/or loyalty programs with the various service providers corresponding to the subscriptions 202. For instance, such attributes can indicate that the customer has a sufficient number of rewards points with a given hotel chain that the customer need not pay for any aspect of their stay at the hotel, including use of various service providing devices in the hotel room. In this example, when the financial profile 130 is synced to a service providing device 108 in a hotel room of that hotel, the service providing device 108 is caused to provide the service without charge to the customer.

Other examples of customer information 208 and information that can define attributes of a financial profile 130 and can be used to generate and configure a dynamic financial protocol are possible.

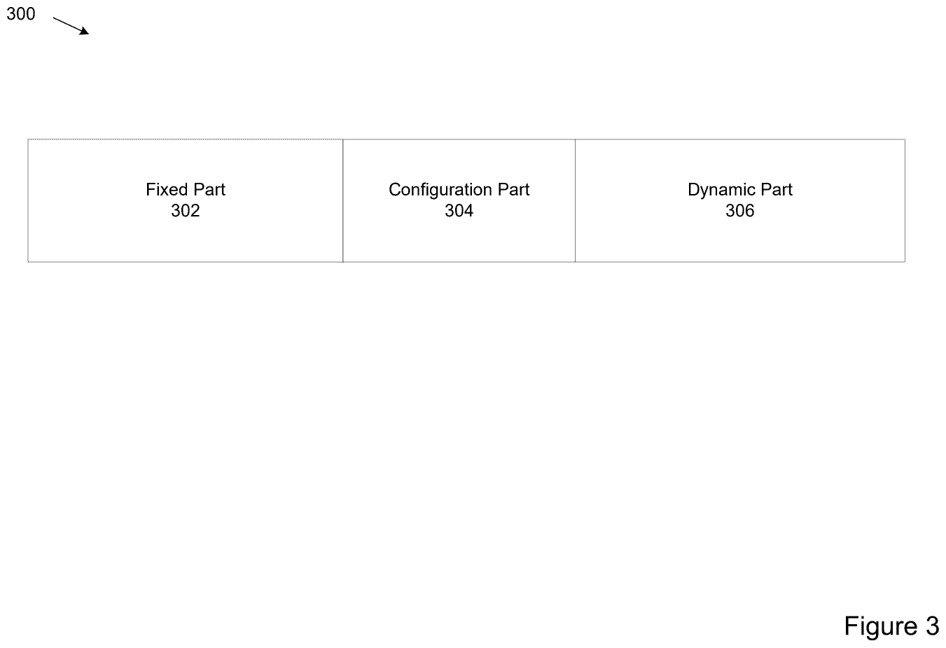

The payment module 122 of the server device 112 of the financial institution is programmed to use a dynamic financial protocol generated from a financial profile that has been synced with a service providing device to initiate the financial transaction that pays for or otherwise compensates the service provider for providing the service, The dynamic financial protocol can be a universally-recognized protocol for processing financial transactions in diverse environments. This dynamic financial protocol can, without limitation, comprise three components captured from the synced financial profile 130 and that are generated in a message 300, as depicted in FIG. 3:
a fixed part 302, which can include the customer's identification credential, one or more associated bank account numbers, and a financial identifier that uniquely identifies each transaction;
a configuration part 304, which can encompass recipient account details, GPS location, payment channel/gateway information, and other transaction-specific configurations for the current financial transaction; and/or
a dynamic part 306, which can be a multidimensional array containing other information from the synced financial profile, such as one or more subscription attributes that correlate to the synced service providing device, one or more service preference attributes that correlate to the service provided by the synced service providing device, one or more payment preference that correlates to the subscription, and/or one or more other customer information attributes, as described above.

The dynamic part 306 can be dynamically evolving based on the nature of the initiated transaction (peer-to-peer, business-to-consumer, application-based, bank-to-bank, within-us transactions, etc.) initiated by the customer.

In some examples, the fixed part 302 and the configuration part 304 of the message 300 are fixed in length. Conversely, the dynamic part 306 can be variable in length. For instance, the dynamic part 306 can vary in length based upon the type of financial transaction and/or information captured by the server device 112 from the financial profile 130 for inclusion in the dynamic financial protocol, such as the type of service providing device that has been synced and the terms of the corresponding subscription.

The server device 112 is programmed to generate a Financial Identifier (FIN) for each financial transaction corresponding to a synced service providing device. This involves automatically creating the FIN number and dynamic part as per the specifications defined in the dynamic financial protocol.

For instance, in one example, the server device 112 generates a FIN for each financial transaction based on information captured in the dynamic financial protocol. In some examples, the FIN is a Globally Unique Identifier (GUID) that uniquely identifies each financial transaction within the system 100.

The payment module 122 of the server device 112 is programmed to execute the financial transaction for the service provided by the synced service providing device once the FIN has been created. Generally, this can include communicating with the third party device 106 using the dynamic financial protocol to accomplish the financial transaction.

Referring to FIGS. 1-2, in an example implementation of the system 100, a customer enters a hotel room with client device A 102. The client device A 102 detects (e.g., via a network interface unit) that it can communicate over the network 110 (e.g., via NFC or WiFi) to the service providing device 108 in the hotel room which is, in this case, a television configured as an IoT device.

The client device A 102 sends a message to the server device 112 that the client device A 102 and the service providing device 108 are able to communicate with each other over a network. The message prompts the messaging module 124 to generate a prompt that is sent to the client device A 102 and can be generated, e.g., by an output device of the client device A 102.

The prompt requests whether the service providing device 108 and the customer's financial profile 130 should be synchronized.

The customer then responds to the prompt at the client device A 102, e.g., by sending a message, using the client device A 102 to the server device 112 confirming that the service providing device 108 and the customer's financial profile 130 should be synchronized.

The syncing module 120 then identifies the financial profile of the customer based on the customer's identification information and further identifies the portion (e.g., the set of attributes) of the customer's financial profile 130 that are relevant to the service that can be provided by the service providing device 108.

For example, the syncing module 120 can receive identification information (e.g., an IP address) and other data from the service providing device 108 sufficient for the server device 112 to determine the service provider who should be paid for the service provided by the service providing device 108, the type of service provided by the service providing device 108 and, thereby, the corresponding attributes of the financial profile 130 that are relevant to the service providing device 108. The identifying information received from the service providing device 108 can also be used by the server device 112 to transmit signals that cause the controller 109 to operate the service providing device 108 in a particular way and according to the identified attributes of the financial profile 130.

Based on the set of attributes identified and the identifying information provided by the service providing device 108, the syncing module 120 causes the server device 112 to generate and send signals that are received by the controller 109 of the service providing device 108 and are configured to control operation of the service providing device 108 according to the identified attributes. For instance, the controller 109 causes an interface to be displayed on the television that offers various content to be streamed free of charge, and also offers to stream a particular movie for three dollars, which offers are based on the attributes defined by the corresponding subscription 202 and corresponding service preferences 204 of the customer's financial profile.

The control signals can provide directly to the service providing device 108 from the server device 112, or be sent via the client device A 102. For instance, the server device 112 can generate and transmit signals that are received by the client device A 102 and cause the client device A 102 to transmit signals to the service providing device 108 to control operation of the service providing device 108 according to the identified portion of the financial profile 130. In this manner, the service providing device 108, the client device A 102 and the financial profile 130 are all synchronized to one another.

Once the customer selects on the television (or on the client device A 102) to watch the particular movie for three dollars, the payment module 122 generates and configures a dynamic financial protocol based on the relevant attributes of the corresponding payment preferences 206, subscription 202, customer information 208 and, in some examples, payee account details captured by the server device 112 from the service providing device 108. The payment module 122 then executes the dynamic financial protocol causing three dollars to be transferred via the customer's preferred payment method for the transaction in question to transaction account of the service provider (e.g., the hotel or a media streaming company) managed on the third party device 106.

The television 108 and the financial profile 130 are unsynchronized by the server device 112 when the server device 112 receives a message from the corresponding client device 102 indicating that the client device 102 is no longer able to communicate with the television 108 over the network 110 (e.g., is no longer in the hotel room), or indicating that the customer has checked out of the hotel, and the like.

In another example implementation of the system 100, a customer enters a friend's home and the server device 112 syncs a service providing device which is, in this case, the friend's WiFi router, to the customer's financial profile 130. The syncing of the friend's WiFi router 108 to the customer's financial profile causes the controller of the WiFi router 108 to provide WiFi service according to the data plan the customer has with their ISP as reflected in the customer's financial profile 130.

For instance, the server device 112 causes the controller 109 of the WiFi router 108 to step down the WiFi signal from 2 GBPS to 1 GBPS because the synced financial profile 130 reflects that the customer has a 1 GBPS plan with their ISP.

In another instance, the WiFi router 108 continues to provide a 2 GBPS signal and a dynamic financial protocol is automatically generated based on the customer's financial profile 130 that causes a payment to be made to the ISP from the customer for the faster data rate according to a predefined fee the customer agreed to pay in the corresponding service agreement for accessing internet at 2 GBPS.

In certain examples, a given service providing device can be configured to provide services at multiple levels simultaneously. For example, the client device A 102 consumes WiFi at 1 GBPS while the client device B 102 consumes WiFi generated by the same router at 2 GBPS, with the customers of the two different client devices being automatically debited according to their respective service agreements with the ISP as set forth in customers'respective ISP subscriptions reflected in the customer's respective financial profiles.

Other examples exist in which syncing of a financial profile to a service providing device can cause the service providing device to operate to provide service at different levels (e.g., stepped up level or a stepped down level).

Other examples exist in which syncing of a financial profile to a service providing device can automatically cause an automatic fee or toll adjustment (up or down) for a service provided by the service providing device based on a level and/or type of service that can be provided by the service providing device and the corresponding tolls or fees agreed to by the customer in the corresponding service agreement.

In another example implementation of the system 100, two customers, corresponding, respectively, to the client devices 102 and 104, are in a hotel room together. In this example, the service providing device 108 is an air conditioner in the hotel room. Separately, the server device 112 can sync each customer's financial profile to the air conditioner 108.

The synchronization of both financial profiles causes the controller 109 of the air conditioner 108 to turn on the air conditioner 108 while both of the client devices 102 and 104 are detected to be able to communicate over a network with the air conditioner 108 and to set the thermostat of the air conditioner to a temperature that corresponds to, e.g., the preferred room temperature of the first customer as defined by an attribute of that customer's financial profile, the preferred room temperature of the second customer as defined by an attribute of that customer's financial profile, or some combination (e.g., an average) of the two preferred temperatures.

For the period of time that the air conditioning is running while both client devices 102 and 104 are in the hotel room (and therefore able to communicate with the air conditioner 108 over the network 110), the server device 112 can generate a dynamic financial protocol for each customer where payment for the air conditioning provided by the air conditioner 108 is split according to an algorithm (e.g., divided evenly) defined in the respective financial protocols. Execution of the respective financial protocols causes the split payment to be made to the service provider (e.g., the electricity supplier or the hotel).

In some instances, if one of the customers leaves the room with their client device 102, 104 or checks out early, the controller 109 can be caused to be automatically adjusted to the preferences of the remaining customer and the dynamic financial protocol of the remaining customer can be adjusted to reflect that going forward that customer is responsible for full payment to the service provider for the electricity consumed by the air conditioner 108.

Other examples of syncing a service providing device to multiple customer financial profiles such that multiple financial profiles are synced to the same service providing device, as well as allocating a service provided by a service providing device to multiple customers, and paying for that service by the multiple customers, all based on different attributes of multiple financial profiles 130, are possible.

In another example implementation of the system 100, if one financial profile is currently synced with a given service providing device 108, then the server device 112 prevents another client device from syncing that service providing device 108 to another financial profile. For example, if the service provided by the service providing device (e.g., a television) is not one that is conducive to allocation between multiple customers at the same time, the server device 112 is configured to permit syncing of the device to only one financial profile at a time.

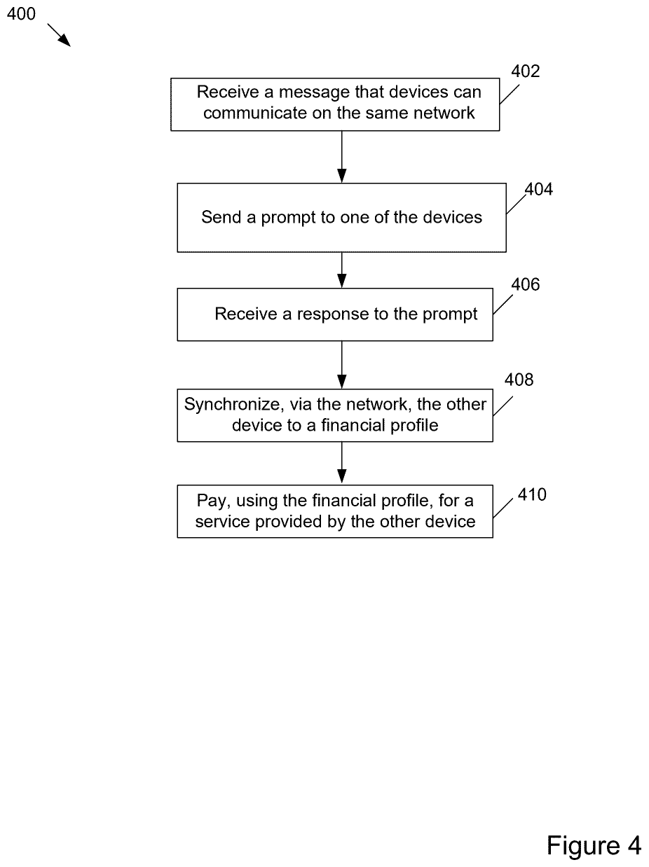

FIG. 4 shows an example method 400 that can be performed using the system of FIG. 1.

Methods of the present disclosure can include more or fewer steps than the enumerated steps of method 400. Methods of the present disclosure can include steps of the method 400 performed in a different order than depicted. In some examples, at least some of the steps of the method 400 are performed by the server device 112. In some examples, some of the steps of the method 400 are performed by one or more other devices of the system 100.

At a step 402 of the method 400, a message is received indicating that a client device and a service providing device are positioned such that they can communicate with each other over a network.

At a step 404 of the method 400, a prompt is sent to the client device.

At a step 406 of the method 400, a response to the prompt is received.

At a step 408 of the method 400, the service providing device and, in some cases, also the client device, are synchronized.

At a step 410 of the method 400, a transaction is executed that pays a service provided for a service provided by the service providing device as a result of the synchronization.

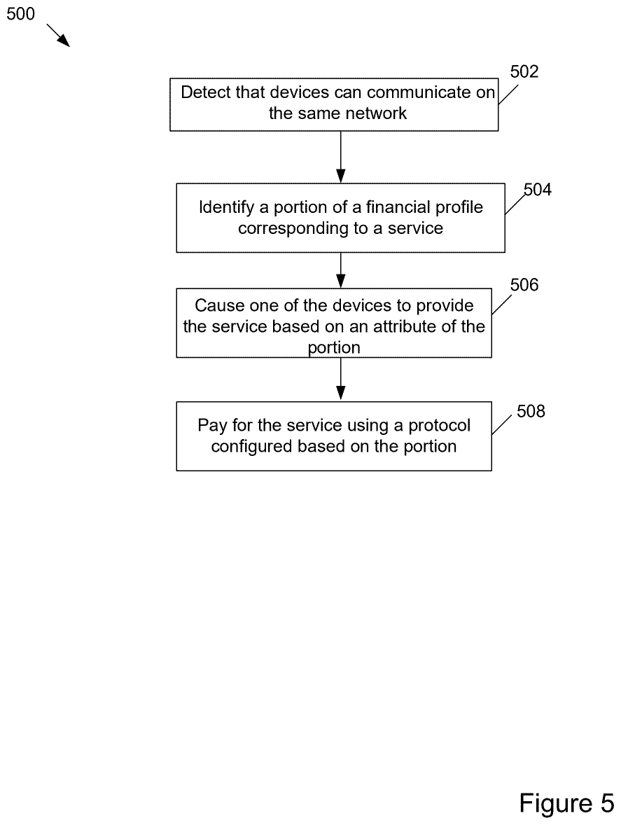

FIG. 5 shows another example method that can be performed using the system of FIG. 1.

Methods of the present disclosure can include more or fewer steps than the enumerated steps of method 500. Methods of the present disclosure can include steps of the method 500 performed in a different order than depicted. In some examples, at least some of the steps of the method 500 are performed by the server device 112. In some examples, some of the steps of the method 500 are performed by one or more other devices of the system 100.

At a step 502 of the method 500 it is detected that a client device and a service providing device can communicate on the same network.

At a step 504 of the method 500, a portion of a financial profile corresponding to a service that can be provided by the service providing device is identified.

At a step 506 of the method 500, the service providing device is caused to provide the service based on an attribute of the portion of the financial profile identified. In some examples, the step 506 occurs once the financial profile and the service providing device have been synchronized to each other.

At a step 508 of the method 500, the service provided by the service providing device is paid for using a dynamic financial protocol that has been generated and configured based on the identified portion of the financial profile.

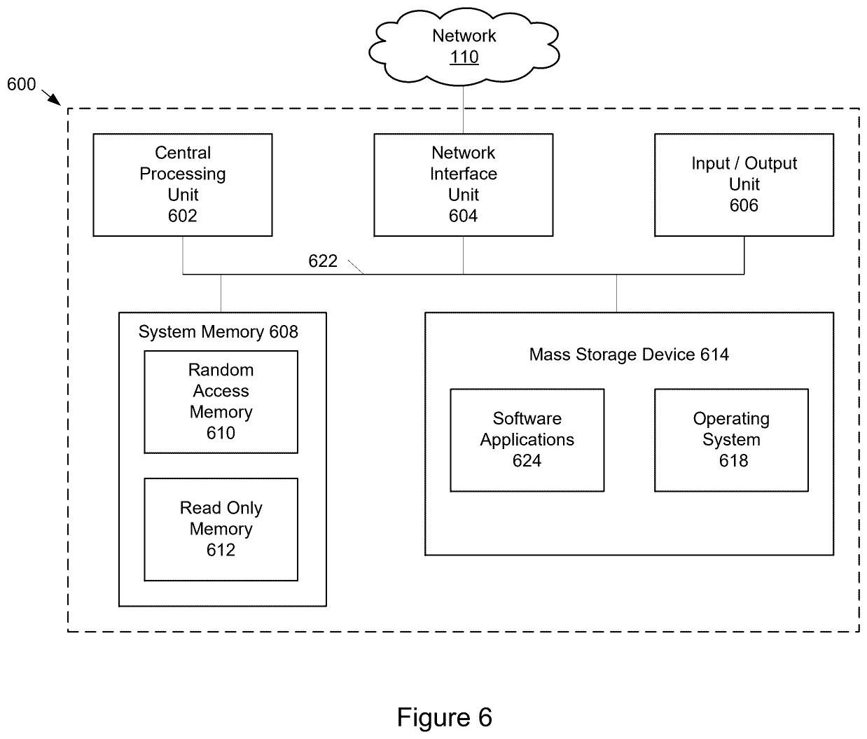

Additional components of the system 100 of FIG. 1 are illustrated in FIG. 6.

The electronic computing device 600 can correspond to any of the server device 112, the client device A 102, the client device B 104, the service providing device 108, or the third party device 106 of FIG. 1. Components of the computing device 600 can correspond to other components of the system 100 of FIG. 1, such as the database(s) 114.

When the computing device 600 corresponds to the server device 112, the computing device 600 can be an internally controlled and managed device (or multiple devices) of an enterprise, e.g., a financial institution that offers various banking services to its customers. Alternatively, the computing device 600 can represent one or more devices operating in a shared computing system external to the enterprise, such as a cloud.

As illustrated in the embodiment of FIG. 6, the example computing device 600, which provides the functionality described herein, can include at least one central processing unit (“CPU”) 602, a system memory 608, and a system bus 622 that couples the system memory 608 to the CPU 602. The system memory 608 includes a random access memory (“RAM”) 610 and a read-only memory (“ROM”) 612. A basic input/output system containing the basic routines that help transfer information between elements within the computing device 600, such as during startup, is stored in the ROM 612. The computing device 600 further includes a mass storage device 614. The mass storage device 614 can store software instructions and data. A central processing unit, system memory, and mass storage device similar to that shown can also be included in the other computing devices disclosed herein.

The mass storage device 614 is connected to the CPU 602 through a mass storage controller (not shown) connected to the system bus 622. The mass storage device 614 and its associated computer-readable data storage media provide non-volatile, non-transitory storage for the computing device 600. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 600.

According to various embodiments of the invention, the computing device 600 may operate in a networked environment using logical connections to remote network devices through network 110, such as a wireless network, the Internet, an NFC network, or another type of network, or combination of networks. The computing device 600 may connect to a network 110 through a network interface unit 604 connected to the system bus 622. For example, detection that a service providing device 108 and a client device 102, 104 are positioned to communicate with each other over a network, such as the network 110, can be based on signals generated by the network interface units of the respective devices. It should be appreciated that the network interface unit 604 may also be utilized to connect to other types of networks and remote computing systems. The computing device 600 also includes an input/output controller 606 for receiving and processing input from a number of other devices, including a touch user interface display screen or another type of input device. Similarly, the input/output controller 606 may provide output to a touch user interface display screen or other output devices.

As mentioned briefly above, the mass storage device 614 and the RAM 610 of the computing device 600 can store software instructions and data. The software instructions include an operating system 618 suitable for controlling the operation of the computing devices of the system 100. The mass storage device 614 and/or the RAM 610 also store software instructions and applications 624, that when executed by the CPU 602, cause the computing device 600 to provide the functionality of the various devices of the system 100 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer system for synchronizing a financial profile to a device, comprising:
one or more processors; and
non-transitory computer-readable storage media encoding instructions which, when executed by the one or more processors, causes the computer system to:
receive a message from a computing device indicating that the computing device and a service providing device are positioned to communicate with each other through a network, the service providing device being configured to provide a service;
send a prompt to the computing device, the prompt requesting whether the service providing device should be synchronized to the financial profile, the financial profile being used to configure a dynamic financial protocol for paying a service provider associated with the service providing device, wherein the financial profile includes a term of a service agreement for providing the service, the service agreement being between the service provider and a user associated with the computing device;
receive a response to the prompt from the computing device, the response requesting to synchronize the service providing device to the financial profile; and
based on the response, synchronize, via the network, the service providing device to the financial profile, causing:
(i) the service providing device to provide the service according to the term of the service agreement; and
(ii) payment to be made for the service provided by the service providing device,
wherein the service providing device is one of a modem, an Internet router, a media playback device, a lighting device, an air conditioner, a heater, or a faucet; and
wherein the service includes provision of at least one of data streaming, media content, air conditioning, heating, lighting, water, or electricity.

2-4. (canceled)

5. The computer system of claim 1, wherein the service includes the provision of data streaming and the term includes a data streaming rate.

6. The computer system of claim 5, wherein the service providing device includes the modem or the Internet router.

7. The computer system of claim 1, wherein the service includes the provision of data streaming and the term includes an identification of a media content item.

8. The computer system of claim 7, wherein the service providing device includes the media playback device.

9. The computer system of claim 1, wherein the service includes the provision of air conditioning, heating, or water and the term includes a predefined maximum amount to spend on the air conditioning, the heating, or the water.

10. The computer system of claim 1, wherein the service includes the provision of air conditioning or heating and the term includes a predefined desired temperature.

11. The computer system of claim 1,
wherein the financial profile defines another attribute of another service; and
wherein the financial profile is used to configure another dynamic financial protocol for paying another service provider for the another service.

12. The computer system of claim 1, wherein the network is one of a WiFi network or a near field communication network.

13. The computer system of claim 1, wherein the instructions, when executed by the one or more processors, causes the computer system, while the service providing device and the financial profile are synchronized, to synchronize, via the network, the service providing device to another financial profile associated within another computing device positioned to communicate with the service providing device through the network.

14. The computer system of claim 13, wherein synchronization of the service providing device to the another financial profile causes payments for the service to be divided between a transaction account associated with the financial profile and another transaction account associated with the another financial profile.

15. The computer system of claim 1, wherein the instructions, when executed by the one or more processors, causes the computer system, while the service providing device and the financial profile are synchronized, to:
receive another message from another computing device indicating that the another computing device and the service providing device are positioned to communicate with each other through the network; and
determine, based on a status of the service providing device and the financial profile being synchronized, not to synchronize the service providing device and another financial profile associated with the another computing device.

16. The computer system of claim 1, wherein the financial profile is used to configure another dynamic financial protocol for paying another service provider associated with another service providing device that is positioned to communicate with the computing device through the network.

17. The computer system of claim 16, wherein the service is data streaming and the another service is one or more of water, heating, air conditioning, or electricity.

18-20. (canceled)
